(19) United States
(12) Patent Application Publication
(10) Pub. No.: US 2020/0150972 A1
(43) Pub. Date: May 14, 2020

(54) PERFORMING ACTIONS OPPORTUNISTICALLY IN CONNECTION WITH REBOOT EVENTS IN A CLOUD COMPUTING SYSTEM

(71) Applicant: Microsoft Technology Licensing, LLC, Redmond, WA (US)

(72) Inventors: Abhay Sudhir KETKAR, Redmond, WA (US); Gaurav JAGTIANI, Bellevue, WA (US); Ajay MANI, Woodinville, WA (US); Richard Thomas RUSSO, Woodinville, WA (US); Shweta Balkrishna PATIL, Redmond, WA (US); James Cameron WHITE, Snohomish, WA (US)

(21) Appl. No.: 16/186,340

(22) Filed: Nov. 9, 2018

(51) Int. Cl. G06F 9/4401; G06F 9/455; G06F 8/65; G06F 9/445; G06F 9/48; H04L 29/08

(52) U.S. Cl. CPC G06F 9/4401; G06F 9/45558; G06F 8/65; G06F 2009/4557; G06F 9/4856; H04L 67/10; G06F 2009/45575; G06F 9/44505

(57) ABSTRACT

A method for opportunistically performing an action in a cloud computing system may include detecting a reboot event corresponding to a computing entity in the cloud computing system. The computing entity may be, for example, a host machine in the cloud computing system or a virtual machine in the cloud computing system. The method may also include causing the computing entity to be held in a stopped state and performing the action while the computing entity is being held in the stopped state, thereby eliminating a need to perform the action at a future time subsequent to the reboot event. The nature of the action is such that it would affect the computing entity if the action were performed subsequent to the reboot event. The method may also include causing the computing entity to be started after the action has been performed.

### CROSS-REFERENCE TO RELATED APPLICATIONS

N/A

### BACKGROUND

Cloud computing is the delivery of computing services (e.g., servers, storage, databases, networking, software, analytics) over the Internet. Broadly speaking, a cloud computing system includes two sections, a front end and a back end, that are in communication with one another via the Internet. The front end includes the interface that users encounter through a client device. The back end includes the resources that deliver cloud-computing services, including processors, memory, storage, and networking hardware.

The back end of a cloud computing system typically includes one or more data centers, which may be located in different geographical areas. Each data center typically includes a large number (e.g., hundreds or thousands) of host machines. Each host machine may be used to run one or more virtual machines. In this context, the term “host machine” refers to a physical computer system, while the term “virtual machine” refers to an emulation of a computer system on a host machine. In other words, a virtual machine is a program running on a host machine that acts like a virtual computer. Like a physical computer, a virtual machine runs an operating system and one or more applications.

Many organizations use cloud computing systems to perform a variety of tasks, such as running applications. To facilitate this, an organization may purchase, from a cloud provider, access to one or more virtual machines on a cloud computing system. There are many benefits to such an approach, including the flexibility that it provides. When demand for an application increases, additional virtual machines may be purchased. Conversely, when demand decreases, the virtual machines that are no longer needed may be shut down. The use of third-party cloud computing systems enables organizations to focus more closely on their core businesses instead of expending resources on computer infrastructure and maintenance.

### BRIEF DESCRIPTION OF THE DRAWINGS

FIG. 1 illustrates an example of a cloud computing system that is configured to opportunistically perform maintenance or other types of actions in accordance with the present disclosure.

FIG. 2 illustrates an example of a method that may be implemented by components of a cloud computing system in connection with a reboot event corresponding to a virtual machine.

FIG. 3 illustrates another example of a method that may be implemented by components of a cloud computing system in connection with a reboot event corresponding to a virtual machine, as well as data structures that may be exchanged by these components in connection therewith.

FIG. 4 illustrates an example of a cloud computing system in which a virtual machine may be moved from one host machine to another when a host machine and/or a virtual machine is being held in a stopped state.

FIG. 5 illustrates an example of a method for opportunistically performing an action in a cloud computing system in accordance with the present disclosure.

FIG. 6 illustrates certain components that may be included within a computer system.

### DETAILED DESCRIPTION

From time to time, various operations or actions may be performed with respect to a cloud computing system. Some of these actions involve performing maintenance operations on software or hardware components in order to keep the cloud computing system running smoothly. In order to perform maintenance operations or other kinds of actions, host machines and virtual machines in the cloud computing system may be rebooted or affected in other ways.

For example, updating an operating system on a host machine typically requires the host machine to reboot, which also requires all of the virtual machines that are running on the host machine to reboot. Similarly, moving a virtual machine from one host machine to another requires the virtual machine to reboot. Sometimes actions may be taken that do not cause a host machine or a virtual machine to reboot, but that still affect the host machine or the virtual machine in other ways. For example, an update to networking components may cause a host machine to at least temporarily lose network connectivity, which causes the virtual machines running on that host machine to also lose network connectivity even if they aren't required to reboot.

Frequently rebooting host machines and/or virtual machines (or affecting them in other ways) may be undesirable. If a customer that has purchased the use of virtual machines from a cloud computing provider notices that the virtual machines are frequently being rebooted or affected in other ways, the customer may become frustrated and consider switching to a different cloud computing provider.

The present disclosure is generally related to minimizing how frequently actions are taken that affect host machines and/or virtual machines in a cloud computing system. In accordance with the present disclosure, maintenance or other types of actions that should be performed with respect to a cloud computing system may be performed opportunistically. For example, reboot events that occur for other reasons (e.g., customer-initiated reboot events, reboot events that are required because a host machine or virtual machine has become unresponsive) may be seen as opportunities to perform maintenance or other types of actions that affect one or more host machines and/or virtual machines. Taking advantage of these opportunities eliminates the need to perform such actions at a future time, thereby reducing the number of times that host machines and/or virtual machines are rebooted or otherwise affected.

In accordance with the present disclosure, a cloud computing system may be configured to detect whenever a reboot event corresponding to a computing entity (e.g., a host machine or a virtual machine) in the cloud computing system is occurring. If there are any actions (maintenance or otherwise) that should be performed with respect to the cloud computing system and that would affect the computing entity (e.g., by causing the computing entity to reboot or by affecting the computing in another way, such as causing the computing entity to lose network connectivity), the cloud computing system may take advantage of the reboot event to perform such actions, thereby eliminating the need to perform the actions at a subsequent time. In other words, the maintenance or other actions may be timed to coincide with reboot events that are going to occur anyway for other reasons, thereby minimizing the overall impact to host machines and virtual machines in the cloud computing system.

In this context, the term “reboot event” refers to the process of rebooting a computing entity, such as a host machine and/or a virtual machine. A reboot event corresponding to a computing entity may include stopping the computing entity and then subsequently starting the computing entity. In accordance with the present disclosure, when a reboot event is detected, the computing entity may be held in the stopped state while one or more actions that affect the computing entity are performed. Once the actions have been completed, the computing entity may be started.

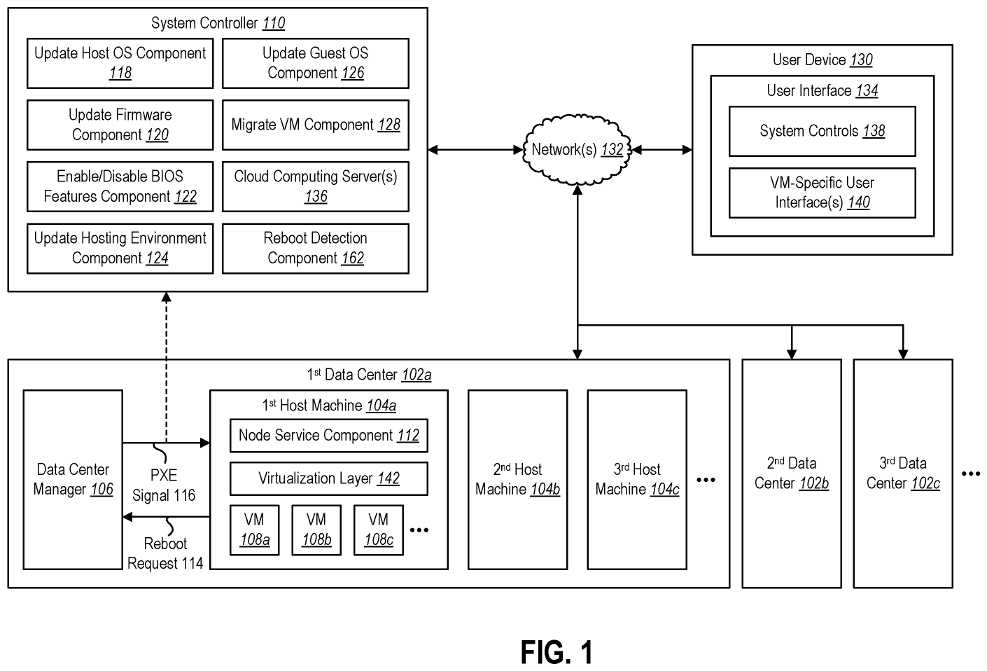

FIG. 1 illustrates an example of a cloud computing system 100 that is configured to opportunistically perform maintenance or other types of actions in accordance with the present disclosure. The system 100 includes a plurality of data centers 102a-c. The first data center 102a is shown with a plurality of host machines 104a-c and a data center manager 106. The host machines 104a-c may each be used to run zero or more virtual machines at any given time. In the depicted example, the first host machine 104a is shown with three virtual machines 108a-c. The first host machine 104a is also shown with a virtualization layer 142, which may alternatively be referred to as a hypervisor layer. The virtualization layer 142 may be configured to keep the virtual machines 108a-c isolated from one another on the first host machine 104a.

For simplicity, only three data centers 102a-c are shown in the system 100, and only three host machines 104a-c are shown in the first data center 102a. However, those skilled in the art will understand that a cloud computing system in accordance with the present disclosure may include more than three data centers, and a data center may include many more than three host machines (e.g., hundreds or thousands of host machines). Also, for simplicity, only the contents of the first data center 102a are shown in FIG. 1. However, the other data centers 102b-c may be configured similarly to the first data center 102a. In other words, the other data centers 102b-c may also include a data center manager and a plurality of host machines running zero or more virtual machines (as well as other components that are not shown in the simplified diagram of FIG. 1). Within the first data center 102a, only the contents of the first host machine 104a are shown in FIG. 1. However, the other host machines 104b-c may be configured similarly to the first host machine 104a.

The system 100 also includes a system controller 110 that is configured to manage the data centers 102a-c and the host machines 104a-c contained therein. To enable the system controller 110 to be able to perform various actions related to the host machines 104a-c in the system 100, each of the host machines 104a-c may include a node service component that is configured to communicate with and perform various actions on behalf of the system controller 110. The node service component that is running on a particular host machine may also be configured to manage any virtual machines that are running on that host machine. FIG. 1 shows a node service component 112 on the first host machine 104a, and a similar component may be running on the other host machines 104b-c.

The system 100 shown in FIG. 1 also includes a user device 130 that is in electronic communication with the system controller 110 and the data centers 102a-c via one or more computer networks 132, which may include the Internet. A user may interact with the system 100 via a user interface 134 on the user device 130. The user interface 134 may communicate with one or more cloud computing servers 136 that are part of the system controller 110. In some implementations, the user interface 134 may take the form of a web browser, and the cloud computing server(s) 136 may include one or more web servers. For simplicity, only a single user device 130 is shown in FIG. 1, but those skilled in the art will understand that a cloud computing system in accordance with the present disclosure may support a large number of users and user devices.

The user interface 134 and the cloud computing servers 136 may enable users to perform various actions related to virtual machines, such as creating new virtual machines, configuring and managing virtual machines, and deleting virtual machines. The user interface 134 may include system controls 138 that enable the user to perform these and other kinds of actions with respect to virtual machines. The user interface 134 on the user device 130 may also include one or more VM-specific user interfaces 140 that correspond to user interfaces of the virtual machines themselves. A VM-specific user interface 140 corresponding to a particular virtual machine (e.g., a virtual machine 108a on the first host machine 104a) may allow the user to view and interact with the applications that are running on that virtual machine 108a, just like the user interface of a desktop computer allows the user of the desktop computer to view and interact with the applications that are running on that desktop computer. The VM-specific user interface 140 may also allow the user to take certain actions with respect to the virtual machine 108a, such as rebooting the virtual machine 108a.

Rebooting a computing entity (such as the first host machine 104a or the virtual machine 108a running on the first host machine 104a) involves stopping the computing entity and then restarting the computing entity. In accordance with the present disclosure, whenever a reboot event corresponding to a computing entity is detected, the computing entity may be held in a stopped state so that the system controller 110 can perform one or more actions while the computing entity is being held in the stopped state. Once the actions have been completed, the computing entity may then be started.

The process for detecting and responding to reboot events corresponding to host machines may be somewhat different than the process for detecting and responding to reboot events corresponding to virtual machines. The process for detecting and responding to reboot events corresponding to host machines will be discussed first, and then the process for detecting and responding to reboot events corresponding to virtual machines will be discussed subsequently.

A reboot event corresponding to a host machine (e.g., the first host machine 104a) may be initiated by the system controller 110 or by the host machine 104a itself. If the system controller 110 initiates the reboot event, then the system controller 110 is already aware of the reboot event and therefore can take advantage of this opportunity to performance maintenance or other actions related to the host machine 104a.

To detect a reboot event that is initiated by a host machine 104a, the system controller 110 may be configured to listen for signals that indicate that a host machine 104a is going to be rebooted. For example, the system controller 110 may be configured to listen for any preboot execution environment (PXE) signals that are sent to a host machine 104a. FIG. 1 shows the first host machine 104a sending a reboot request 114 to the data center manager 106, and the data center manager 106 responding with a PXE signal 116. The system controller 110 may be configured to detect the PXE signal 116 being sent to the first host machine 104a. The system controller 110 may interpret the PXE signal 116 as an indication that the first host machine 104a is going to be rebooted. Alternatively, the first host machine 104a may directly notify the system controller 110 that the first host machine 104a is going to be rebooted. The system controller 110 is shown with a reboot detection component 162 for providing the functionality of detecting reboot events.

Rebooting the first host machine 104a involves stopping the first host machine 104a and then starting the first host machine 104a. After the first host machine 104a has been stopped, the system controller 110 may cause the first host machine 104a to be held in a stopped state so that the system controller 110 can perform one or more actions that affect the first host machine 104a and/or the virtual machines 108a-c running on the first host machine 104a. Some examples of actions that may be performed will be discussed below. Once the action(s) have been performed, the system controller 110 may cause the first host machine 104a, to be started.

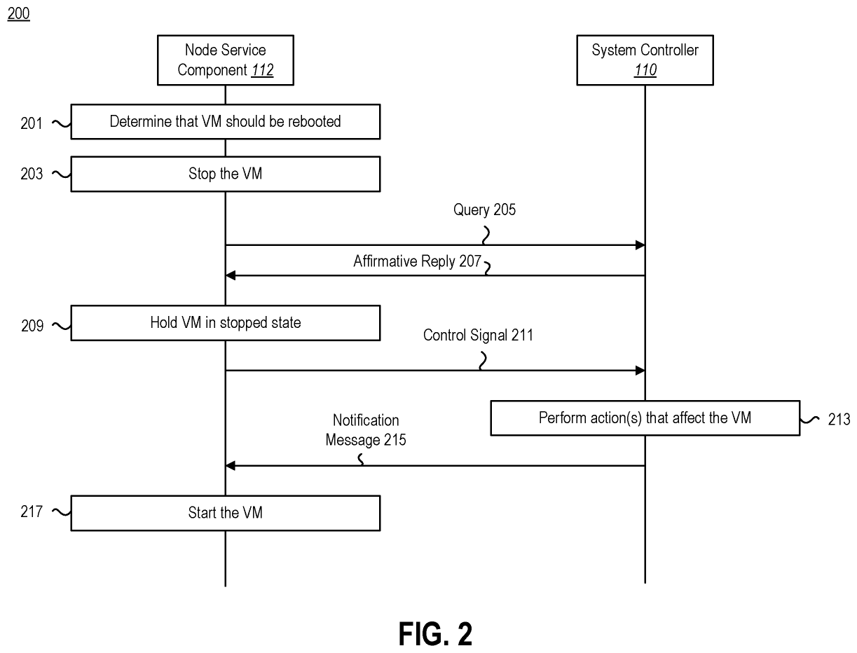

The process for detecting and responding to reboot events corresponding to virtual machines will now be discussed. FIG. 2 illustrates an example of a method 200 that may be implemented by the system controller 110 and the node service component 112 on the first host machine 104a in connection with a reboot event corresponding to a virtual machine. For purposes of the present example, it will be assumed that the virtual machine 108a on the first host machine 104a is being rebooted.

In accordance with the method 200, the node service component 112 may determine 201 that a virtual machine 108a should be rebooted. There are several different ways that this may occur. For example, the system controller 110 may initiate a reboot of the virtual machine 108a. In this scenario, the system controller 110 may send a command to the node service component 112 instructing the node service component 112 to reboot the virtual machine 108a.

As another example, a user may initiate a reboot of the virtual machine 108a. The user may initiate the reboot in at least two different ways. For example, the user may initiate the reboot via the system controls 138 of the user interface 134. In this scenario, the system controller 110 may be aware of the reboot event and may send a command to the node service component 112 instructing the node service component 112 to reboot the virtual machine 108a. Alternatively, the user may initiate the reboot via a VM-specific user interface 140 corresponding to the virtual machine 108a. In this scenario, the system controller 110 may not be aware of the reboot event, and the node service component 112 may be notified about the reboot event via another mechanism. For example, the virtualization layer 142 may notify the node service component 112 about the reboot event.

Regardless of how the node service component 112 determines 201 that a virtual machine 108a should be rebooted, once this occurs, the node service component 112 may stop 203 the virtual machine 108a. After the virtual machine 108a has been stopped 203, the node service component 112 may query 205 the system controller 110 to determine whether the system controller 110 intends to perform any actions that affect the virtual machine 108a while the virtual machine 108a is stopped. If the node service component 112 receives a negative reply or no reply within a defined time period, the node service component 112 may proceed to start the virtual machine 108a again.

If, however, the system controller 110 has identified one or more actions that should be performed that affect the virtual machine 108a, the system controller 110 may respond to the query 205 by sending an affirmative reply 207 back to the node service component 112. In response to receiving the affirmative reply 207 from the system controller 110, the node service component 112 may hold 209 the virtual machine 108a in the stopped state and provide a control signal 211 to the system controller 110 indicating that the system controller 110 can begin to perform whatever action(s) it intends to perform.

In response to receiving the control signal 211 from the node service component 112, the system controller 110 may perform 213 one or more actions that affect the virtual machine 108a. Some examples of actions that may be performed will be discussed below. Once the action(s) have been completed, the system controller 110 may send a notification message 215 notifying the node service component 112 that the action(s) have been completed. In response to receiving the notification message 215, the node service component 112 may start 217 the virtual machine 108a.

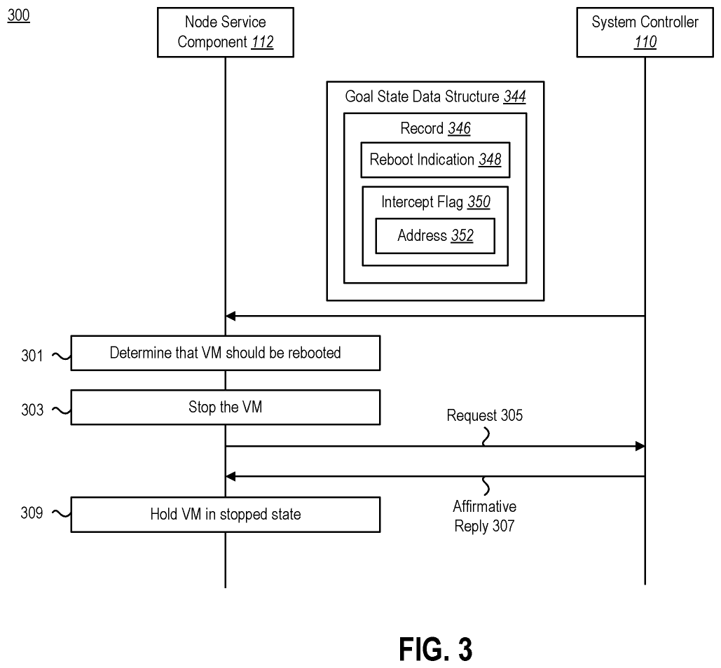

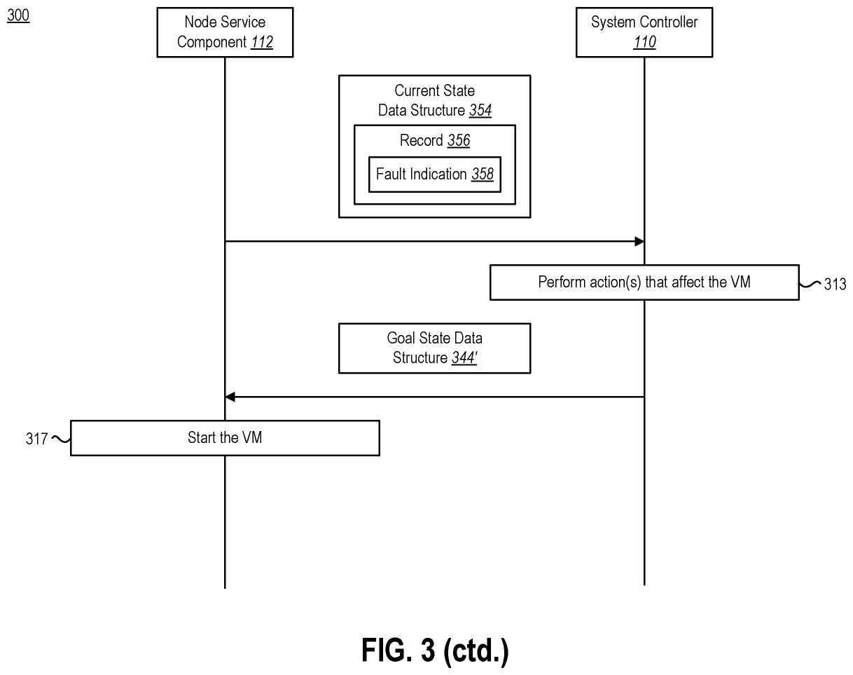

FIG. 3 illustrates a more detailed example of a method 300 that may be implemented by the system controller 110 and the node service component 112 on the first host machine 104a in connection with a reboot event corresponding to a virtual machine 108a. In the method 300 shown in FIG. 3, the system controller 110 and the node service component 112 may periodically exchange data structures that provide information about the virtual machines 108a-c running on the first host machine 104a. In particular, the node service component 112 may periodically send a data structure to the system controller 110 that includes information about the current state of each of the virtual machines 108a-c. This data structure may be referred to herein as a current state data structure. Conversely, the system controller 110 may periodically send a data structure to the node service component 112 that includes information about the goal state (i.e., the desired future state) of each of the virtual machines 108a-c. The node service component 112 may periodically compare the current state data structure with the goal state data structure in order to determine what actions should be performed in order to transition the virtual machines 108a-c from their respective current states (as indicated in the current state data structure) to their respective goal states (as indicated in the goal state data structure).

In accordance with the method 300 shown in FIG. 3, the system controller 110 may send a goal state data structure 344 to the node service component 112 on the first host machine 104a. The goal state data structure 344 may include a record for each of the virtual machines 108a-c on the first host machine 104a. FIG. 3 shows a record 346 corresponding to the virtual machine 108a that is being rebooted. In the depicted example, the record 346 includes a reboot indication 348, which is a command for the node service component 112 to reboot the virtual machine 108a. The record 346 may include the reboot indication 348 if the system controller 110 initiates the reboot, or if the user initiates the reboot via the system controls 138 of the user interface 134. Alternatively, if the user initiates the reboot via the VM-specific user interface 140 corresponding to the virtual machine 108a, the record 346 may not include the reboot indication 348.

The record 346 also includes an intercept flag 350, which is an indication that there are one or more actions that the system controller 110 may want to perform in connection with the reboot of the virtual machine 108a. The intercept flag 350 may include an address 352, which may be a uniform resource locator (URL).

In accordance with the method 300, the node service component 112 may determine 301 that the virtual machine 108a should be rebooted. This determination may be based on the reboot indication 348 in the record 346 corresponding to the virtual machine 108a in the goal state data structure 344. Alternatively, if there is no such reboot indication 348 in the goal state data structure 344, then the node service component 112 may make the determination 301 that the virtual machine 108a should be rebooted via another mechanism. For example, the virtualization layer 142 may notify the node service component 112 about a user-initiated reboot of the virtual machine 108a.

Once the node service component 112 determines 301 that the virtual machine 108a should be rebooted, the node service component 112 may stop 303 the virtual machine 108a. After the virtual machine 108a has been stopped 303, the node service component 112 may query the system controller 110 to determine whether the system controller 110 intends to perform any actions that affect the virtual machine 108a while the virtual machine 108a is stopped. In the depicted example, the node service component 112 may query the system controller 110 by sending a request 305 to the address 352 (e.g., the URL) in the intercept flag 350. If the node service component 112 receives a negative reply or no reply within a defined time period, the node service component 112 may proceed to start the virtual machine 108a again.

If, however, the system controller 110 does intend to perform one or more actions that affect the virtual machine 108a while the virtual machine 108a is stopped, the system controller 110 may respond to the query by sending an affirmative reply 307 back to the node service component 112. In response to receiving the affirmative reply 307 from the system controller 110, the node service component 112 may hold 309 the virtual machine 108a in the stopped state and provide a control signal to the system controller 110 indicating that the system controller 110 can begin to perform whatever action(s) it intends to perform. In the depicted example, providing the control signal may involve sending a current state data structure 354 to the system controller 110. The current state data structure 354 may include a fault indication 358 in a record 356 corresponding to the virtual machine 108a.

The system controller 110 may interpret the fault indication 358 as a sign that the virtual machine 108a is being held in the stopped state and that the system controller 110 is free to proceed with whatever action(s) it intends to perform. In response, the system controller 110 may perform 313 the action(s). Once the action(s) have been completed, the system controller 110 may send a notification message notifying the node service component 112 that the action(s) have been completed. In the depicted example, the notification message may take the form of an updated goal state data structure 344′ that does not include the reboot indication 348 or the intercept flag 350. The node service component 112 may interpret the updated goal state data structure 344′ as an indication that the action(s) have been completed and that the node service component 112 is free to start 317 the virtual machine 108a.

Some examples of actions that may be taken when a host machine is being held in a stopped state include updating an operating system on the host machine, updating firmware on the host machine, enabling or disabling basic input/output system (BIOS) features on the host machine, updating a host machine's hosting environment (i.e., software and other components of a host machine that enable virtual machines to run on the host machine), and moving one or more virtual machines on the host machine to a different host machine. The system controller 110 in FIG. 1 is shown with various components that implement this functionality, including an update host operating system (OS) component 118, an update firmware component 120, an enable/disable BIOS features component 122, an update hosting environment component 124, and a migrate virtual machine (VM) component 128.

Some examples of actions that may be taken when a virtual machine is being held in a stopped state include updating an operating system that is running on the virtual machine (which may be referred to as a guest operating system) and moving the virtual machine to a different host machine. The system controller 110 in FIG. 1 is shown with components that provide this functionality, including an update guest OS component 126 and the migrate VM component 128.

The aforementioned actions are provided for purposes of example only and should not be interpreted as limiting the scope of the present disclosure, which encompasses any actions that affect a host machine and/or a virtual machine. Other examples of actions that may be performed while a host machine and/or a virtual machine is being held in a stopped state will be readily apparent to those skilled in the art.

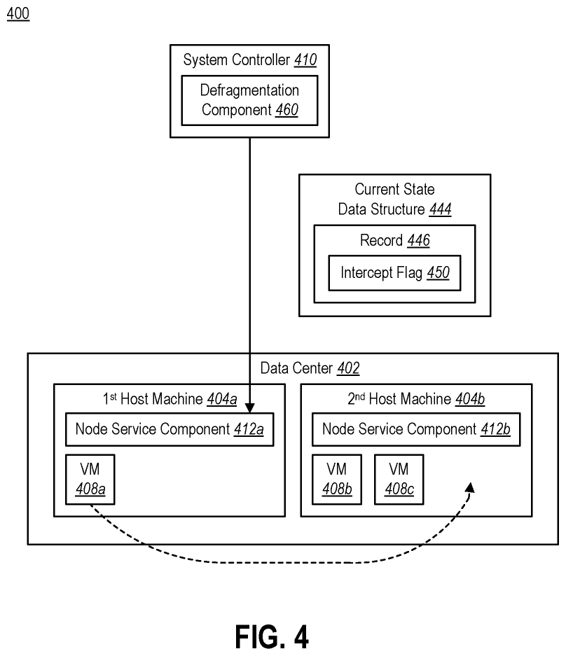

As mentioned previously, a virtual machine may be moved from one host machine to another when a host machine and/or a virtual machine is being held in a stopped state. There are at least two different scenarios in which this may occur. Both of these scenarios will be described in relation to the cloud computing system 400 shown in FIG. 4, which includes a system controller 410 in electronic communication with a data center 402 that includes a first host machine 404a and a second host machine 404b. In the depicted example, a virtual machine 408a is running on the first host machine 404a, and two virtual machines 408b-c are running on the second host machine 404b.

In one scenario, a virtual machine may be moved from one host machine to another for purposes of defragmentation (e.g., to increase overall capacity of the system 400). In FIG. 4, the system controller 410 includes a defragmentation component 460 that may be configured to periodically evaluate whether the virtual machines 408a-c could be arranged more efficiently within the host machines 404a-b. If, for example, the defragmentation component 460 determines that it would increase the overall capacity of the system 400 if the virtual machines 408a-c were all located on the same host machine, then the system controller 410 may move the virtual machine 408a from the first host machine 404a to the second host machine 404b when the first host machine 404a and/or the virtual machine 408a is rebooted.

In some implementations, the defragmentation component 460 may be configured to periodically evaluate the arrangement of the virtual machines 408a-c in the system 400 to determine whether any of them should be moved to a different host machine for defragmentation purposes. When the defragmentation component 460 identifies a virtual machine that should be moved (e.g., the virtual machine 408a on the first host machine 404a), the defragmentation component 460 may set an intercept flag 450 in a record 446 corresponding to that virtual machine 408a in the goal state data structure 444 that is sent to the node service component 412a on the corresponding host machine 404a. In other words, the defragmentation component 460 may set the intercept flag 450 for a subset of the virtual machines in the system 400, namely, the virtual machine(s) that have been identified as candidates to be moved.

In other implementations, the defragmentation component 460 may set an intercept flag 450 for all of the virtual machines 408a-c in the system 400, regardless of whether or not they have been identified as candidates to move to another host machine. In these kinds of implementations, whenever a particular virtual machine (e.g., the virtual machine 408a on the first host machine 404a) is rebooted, the intercept flag 450 causes the corresponding node service component 412a to give the system controller 410 an opportunity to perform action(s) that affect the virtual machine 408a, such as moving the virtual machine 408a to a different host machine. When the node service component 412a gives the system controller 410 this opportunity, the defragmentation component 460 may determine at that time whether it would be desirable to move the virtual machine 408a for defragmentation purposes.

In another scenario, a virtual machine may be moved from a host machine that has not been updated to another host machine that has been updated. For example, referring again to the system 400 shown in FIG. 4, suppose that the second host machine 404b has received one or more updates (e.g., an updated operating system, an updated hosting environment) but the first host machine 404a has not yet been updated. It may, however, be desirable for the virtual machine 408a to run on a host machine that has been updated. Therefore, when the first host machine 404a and/or the virtual machine 408a is rebooted, the system controller 410 may take advantage of this opportunity to move the virtual machine 408a from the first host machine 404a to the second host machine 404b. Alternatively, because the virtual machine 408a is the only virtual machine that is running on the first host machine 404a, the system controller 410 may simply update the first host machine 404a instead of moving the first host machine 404a to another host machine.

Previously, some examples of actions that may be taken when a host machine is being rebooted were provided. In addition, some examples of actions that may be taken when a virtual machine is being rebooted were provided. In a scenario where there is only one virtual machine running on a host machine (e.g., the virtual machine 408a running on the first host machine 404a), then any of the actions that are related to the host machine 404a may also be performed when the virtual machine 408a is rebooted. This is because rebooting the host machine 404a in this situation does not affect any other virtual machines on the host machine 404a (since only one virtual machine 408a is running on the host machine 404a).

Suppose, for example, that the virtual machine 408a is rebooted and that the interaction between the node service component 412a and the system controller 410 occurs generally as discussed above in connection with FIGS. 2 and 3. When the node service component 412a gives the system controller 410 an opportunity to perform action(s) that affect the virtual machine 408a, the system controller 410 may evaluate whether the virtual machine 408a is the only virtual machine running on the corresponding host machine 404a. In response to determining that this is true, the system controller 410 may then decide to perform action(s) that affect the host machine 404a in addition to performing action(s) that affect the virtual machine 408a.

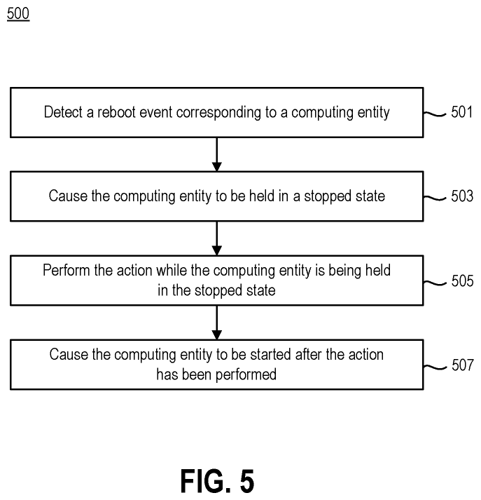

FIG. 5 illustrates an example of a method 500 for opportunistically performing an action in a cloud computing system in accordance with the present disclosure. For the sake of clarity, the method 500 will be discussed in connection with the cloud computing system 100 shown in FIG. 1. The method 500 may be performed by a system controller 110 within the cloud computing system 100.

The method 500 may include detecting 501 a reboot event corresponding to a computing entity in the cloud computing system 100. The computing entity may be, for example, a host machine 104a in the cloud computing system 100 or a virtual machine 108a in the cloud computing system 100. Detecting 501 a reboot event corresponding to a host machine 104a may involve listening for and detecting a preboot execution environment (PXE) signal that is sent to the host machine 104a. Alternatively, detecting 501 a reboot event corresponding to a host machine 104a may involve receiving a message directly from the host machine 104a. The message may either request a reboot or notify the system controller 110 about a reboot.

As indicated above, a reboot event corresponding to a computing entity may involve stopping the computing entity and subsequently starting the computing entity. After the computing entity has been stopped, the method 500 may also include causing 503 the computing entity to be held in a stopped state. If the reboot event corresponds to a host machine 104a, the system controller 110 may hold the host machine 104a in a stopped state by issuing one or more commands to the host machine 104a. If the reboot event corresponds to a virtual machine 108a, the system controller 110 may communicate with a node service component 112 on the corresponding host machine 104a (as discussed above in connection with FIGS. 2 and 3) in order to cause the virtual machine 108a to be held in a stopped state.

The method 500 may also include performing 505 an action while the computing entity is being held in the stopped state, thereby eliminating a need to perform the action at a future time subsequent to the reboot event. The nature of the action may be such that it would affect the computing entity if the action were performed subsequent to the reboot event. For example, the action may be such that it would cause the computing entity to be rebooted again if the action were performed subsequent to the reboot event. Some examples of actions that may be performed were discussed previously.

The method 500 may also include causing 507 the computing entity to be started after the action has been performed. If the reboot event corresponds to a host machine 104a, the system controller 110 may cause the host machine 104a to be started by issuing one or more commands to the host machine 104a. If the reboot event corresponds to a virtual machine 108a, the system controller 110 may communicate with a node service component 112 on the corresponding host machine 104a (as discussed above in connection with FIGS. 2 and 3) in order to cause the virtual machine 108a to be started.

For simplicity, the method 500 has been discussed with respect to performing a single action. However, this should not be interpreted as limiting the scope of the present disclosure. The techniques disclosed herein may, of course, be utilized to perform multiple actions in connection with a reboot event.

Performing maintenance and other types of actions opportunistically in accordance with the present disclosure may provide significant technical benefits relative to current approaches. For example, current approaches do not take advantage of a reboot event to perform other actions beyond whatever caused the reboot event to occur in the first place. Referring again to the system 100 shown in FIG. 1, suppose that the first host machine 104a is being rebooted because it has become unresponsive. With current approaches, the first host machine 104a may be rebooted in order to address this unresponsiveness, but no additional actions would be taken with respect to the first host machine 104a or any of the virtual machines 108a-c running on the first host machine 104a. If there were other actions that should be performed with respect to the first host machine 104a and/or the virtual machines 108a-c, those would be performed at a later time. Unfortunately, performing these actions at a later time would cause the first host machine 104a and/or the virtual machines 108a-c to be rebooted one or more additional times or affected in other ways.

In accordance with the present disclosure, however, one or more additional actions that affect the first host machine 104a and/or the virtual machines 108a-c running on the first host machine 104a may be performed in connection with rebooting the first host machine 104a. Performing these additional action(s) in connection with a reboot event that would have taken place anyway eliminates the need to perform such actions at a future time, thereby reducing the number of times that the first host machine 104a (and the virtual machines 108a-c running on the first host machine 104a) are rebooted or otherwise affected.

Similar technical benefits may be achieved in a scenario where a virtual machine (but not necessarily the host machine on which the virtual machine is running) is being rebooted. Referring still to the system 100 shown in FIG. 1, suppose that a user of the cloud computing system 100 initiates a reboot of the virtual machine 108a on the first host machine 104a. With current approaches, the virtual machine 108a may be rebooted in accordance with the user's wishes, but no additional actions would be taken with respect to the virtual machine 108a. If there were other actions that should be performed with respect to the virtual machine 108a, those would be performed at a later time. However, performing these actions at a later time would cause the virtual machine 108a to be rebooted one or more additional times or affected in other ways.

In accordance with the present disclosure, however, one or more additional actions that affect the virtual machine 108a may be performed in connection with rebooting the virtual machine 108a. For example, if a user of the system 100 initiates a reboot of the virtual machine 108a, one or more additional actions that affect the virtual machine 108a may be performed in connection with rebooting the virtual machine 108a. Performing these additional action(s) in connection with a reboot event that would have taken place anyway eliminates the need to perform such actions at a future time, thereby reducing the number of times that the virtual machine 108a is rebooted or otherwise affected. Thus, maintenance and other types of actions may be performed opportunistically in accordance with the present disclosure in order to minimize the overall number of reboots and/or the overall amount of downtime of the host machines and the virtual machines in a cloud computing system.

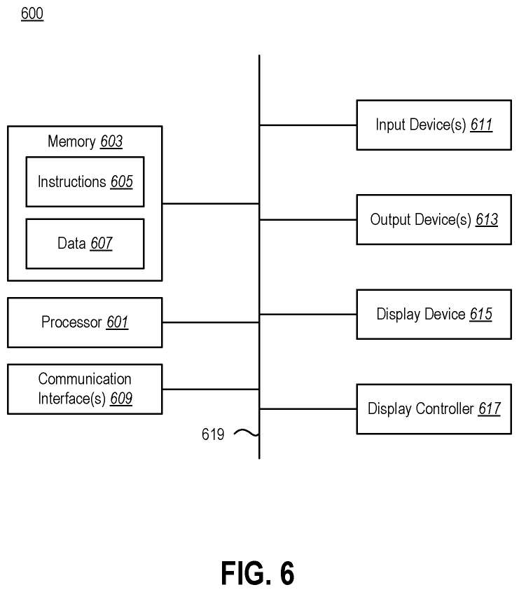

FIG. 6 illustrates certain components that may be included within a computer system 600. One or more computer systems 600 may be used to implement the various devices, components, and systems described herein.

The computer system 600 includes a processor 601. The processor 601 may be a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 601 may be referred to as a central processing unit (CPU). Although just a single processor 601 is shown in the computer system 600 of FIG. 6, in an alternative configuration, a combination of processors (e.g., an ARM and DSP) could be used.

The computer system 600 also includes memory 603 in electronic communication with the processor 601. The memory 603 may be any electronic component capable of storing electronic information. For example, the memory 603 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 605 and data 607 may be stored in the memory 603. The instructions 605 may be executable by the processor 601 to implement some or all of the steps, operations, actions, or other functionality disclosed herein. Executing the instructions 605 may involve the use of the data 607 that is stored in the memory 603. Any of the various examples of modules and components described herein may be implemented, partially or wholly, as instructions 605 stored in memory 603 and executed by the processor 601. Any of the various examples of data described herein may be among the data 607 that is stored in memory 603 and used during execution of the instructions 605 by the processor 601.

A computer system 600 may also include one or more communication interfaces 609 for communicating with other electronic devices. The communication interface(s) 609 may be based on wired communication technology, wireless communication technology, or both. Some examples of communication interfaces 609 include a Universal Serial Bus (USB), an Ethernet adapter, a wireless adapter that operates in accordance with an Institute of Electrical and Electronics Engineers (IEEE) 602.11 wireless communication protocol, a Bluetooth® wireless communication adapter, and an infrared (IR) communication port.

A computer system 600 may also include one or more input devices 611 and one or more output devices 613. Some examples of input devices 611 include a keyboard, mouse, microphone, remote control device, button, joystick, trackball, touchpad, and lightpen. Some examples of output devices 613 include a speaker and a printer. One specific type of output device that is typically included in a computer system 600 is a display device 615. Display devices 615 used with embodiments disclosed herein may utilize any suitable image projection technology, such as liquid crystal display (LCD), light-emitting diode (LED), gas plasma, electroluminescence, or the like. A display controller 617 may also be provided, for converting data 607 stored in the memory 603 into text, graphics, and/or moving images (as appropriate) shown on the display device 615.

The various components of the computer system 600 may be coupled together by one or more buses, which may include a power bus, a control signal bus, a status signal bus, a data bus, etc. For the sake of clarity, the various buses are illustrated in FIG. 6 as a bus system 619.

In accordance with an aspect of the present disclosure, a cloud computing system is disclosed that includes one or more processors and memory. The memory includes instructions that are executable by the one or more processors to perform operations including detecting a reboot event corresponding to a computing entity in the cloud computing system, causing the computing entity to be held in a stopped state, performing an action while the computing entity is being held in the stopped state, and causing the computing entity to be started after the action has been performed. Performing the action while the computing entity is being held in the stopped state may eliminate a need to perform the action at a future time subsequent to the reboot event. The nature of the action may be such that the action would affect the computing entity if the action were performed subsequent to the reboot event.

The computing entity may include a host machine in the cloud computing system. Alternatively, the computing entity may include a virtual machine in the cloud computing system. The nature of the action may be such that the action would cause the computing entity to be rebooted again if the action were performed subsequent to the reboot event.

The computing entity may include a host machine. The system may further include a system controller that is configured to manage a plurality of host machines. The system controller may detect the reboot event by detecting a preboot execution environment signal.

The computing entity may include a virtual machine. The system may further include a node service component that is configured to manage one or more virtual machines. The node service component may be configured to stop the virtual machine; query a system controller to determine whether the system controller intends to perform any actions that affect the virtual machine while the virtual machine is stopped; and in response to receiving an affirmative reply from the system controller, hold the virtual machine in the stopped state and provide a control signal to the system controller indicating that the system controller can begin to perform the action.

The node service component may be configured to stop the virtual machine in response to receiving a goal state data structure from a system controller, the goal state data structure including an intercept flag. Querying the system controller may include calling an address in the intercept flag. Providing the signal to the system controller may include sending the system controller a current state data structure that includes a fault indication associated with the virtual machine.

The computing entity may include a virtual machine. The system may further include a system controller that is configured to manage a plurality of host machines. The controller may be configured to receive a query from a node service component asking whether the system controller intends to perform any actions that affect the virtual machine while the virtual machine is stopped, provide an affirmative reply to the query if the system controller does intend to perform the action while the virtual machine is stopped, receive a control signal from the node service component indicating that the system controller can begin to perform the action, perform the action in response to receiving the control signal, and notify the node service component when the action has been completed.

The system controller may be configured to send a goal state data structure to the node service component. The goal state data structure may include an intercept flag. Receiving the control signal from the node service component may include receiving a current state data structure from the node service component. The current state data structure may include a fault indication associated with the virtual machine. Notifying the node service component when the action has been completed may include sending an updated goal state data structure to the node service component. The updated goal state data structure may not comprise the intercept flag.

The reboot event corresponds to a host machine. The action may include at least one of updating an operating system on the host machine, performing a firmware update on the host machine, enabling or disabling basic input/output system (BIOS) features on the host machine, updating a hosting environment corresponding to the host machine, or moving a virtual machine to a different host machine.

The reboot event corresponds to a virtual machine. The action may include at least one of updating a guest operating system that is running on the virtual machine, or moving the virtual machine to a different host machine.

The system may further include a defragmentation component that is configured to perform at least one of setting an intercept flag for all virtual machines in the cloud computing system or identifying a subset of virtual machines that should be moved to a different host machine in order to create system capacity and setting the intercept flag for the subset of virtual machines.

The computing entity may be a virtual machine that is running on a host machine. The action may be related to the virtual machine. The operations may further include performing an additional action that is related to the host machine in response to determining that no other virtual machines are running on the host machine.

In accordance with another aspect of the present disclosure, a method for opportunistically performing an action in a cloud computing system is disclosed. The method may include detecting a reboot event corresponding to a computing entity in the cloud computing system, causing the computing entity to be held in a stopped state, performing the action while the computing entity is being held in the stopped state, and causing the computing entity to be started after the action has been performed. Performing the action while the computing entity is being held in the stopped state may eliminate a need to perform the action at a future time subsequent to the reboot event. The action would affect the computing entity if the action were performed subsequent to the reboot event.

The computing entity may include a host machine in the cloud computing system. Alternatively, the computing entity may include a virtual machine in the cloud computing system. The nature of the action may be such that the action would cause the computing entity to be rebooted again if the action were performed subsequent to the reboot event.

In accordance with another aspect of the present disclosure, a computer-readable medium is disclosed that includes computer-executable instructions. When executed, the instructions cause one or more processors to perform operations including detecting a reboot event corresponding to a computing entity in the cloud computing system, causing the computing entity to be held in a stopped state, performing an action while the computing entity is being held in the stopped state, and causing the computing entity to be started after the action has been performed. Performing the action while the computing entity is being held in the stopped state may eliminate a need to perform the action at a future time subsequent to the reboot event. The action would affect the computing entity if the action were performed subsequent to the reboot event.

The computing entity may include a host machine in the cloud computing system. Alternatively, the computing entity may include a virtual machine in the cloud computing system. The nature of the action may be such that the action would cause the computing entity to be rebooted again if the action were performed subsequent to the reboot event.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory computer-readable medium having computer-executable instructions stored thereon that, when executed by at least one processor, perform some or all of the steps, operations, actions, or other functionality disclosed herein. The instructions may be organized into routines, programs, objects, components, data structures, etc., which may perform particular tasks and/or implement particular data types, and which may be combined or distributed as desired in various embodiments.

The steps, operations, and/or actions of the methods described herein may be interchanged with one another without departing from the scope of the claims. In other words, unless a specific order of steps, operations, and/or actions is required for proper functioning of the method that is being described, the order and/or use of specific steps, operations, and/or actions may be modified without departing from the scope of the claims.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A cloud computing system, comprising:
one or more processors; and
memory comprising instructions that are executable by the one or more processors to perform operations comprising:
detecting a reboot event corresponding to a computing entity in the cloud computing system;
causing the computing entity to be held in a stopped state;
performing an action while the computing entity is being held in the stopped state, thereby eliminating a need to perform the action at a future time subsequent to the reboot event, wherein the action would affect the computing entity if the action were performed subsequent to the reboot event; and
causing the computing entity to be started after the action has been performed.

2. The system of claim 1, wherein the computing entity comprises a host machine in the cloud computing system.

3. The system of claim 1, wherein the computing entity comprises a virtual machine in the cloud computing system.

4. The system of claim 1, wherein the action would cause the computing entity to be rebooted again if the action were performed subsequent to the reboot event.

5. The system of claim 1, wherein:
the computing entity comprises a host machine;
the system further comprises a system controller that is configured to manage a plurality of host machines; and
the system controller detects the reboot event by detecting a preboot execution environment signal.

6. The system of claim 1, wherein:
the computing entity comprises a virtual machine;
the system further comprises a node service component that is configured to manage one or more virtual machines; and
the node service component is configured to:
stop the virtual machine;
query a system controller to determine whether the system controller intends to perform any actions that affect the virtual machine while the virtual machine is stopped; and
in response to receiving an affirmative reply from the system controller, hold the virtual machine in the stopped state and provide a control signal to the system controller indicating that the system controller can begin to perform the action.

7. The system of claim 6, wherein:
the node service component is configured to stop the virtual machine in response to receiving a goal state data structure from the system controller, the goal state data structure comprising an intercept flag;
querying the system controller comprises calling an address in the intercept flag; and
providing the control signal to the system controller comprises sending the system controller a current state data structure that comprises a fault indication associated with the virtual machine.

8. The system of claim 1, wherein:
the computing entity comprises a virtual machine;
the system further comprises a system controller that is configured to manage a plurality of host machines; and
the system controller is configured to:
receive a query from a node service component asking whether the system controller intends to perform any actions that affect the virtual machine while the virtual machine is stopped;
provide an affirmative reply to the query if the system controller does intend to perform the action while the virtual machine is stopped;
receive a control signal from the node service component indicating that the system controller can begin to perform the action;
perform the action in response to receiving the control signal; and
notify the node service component when the action has been completed.

9. The system of claim 8, wherein:
the system controller is configured to send a goal state data structure to the node service component;
the goal state data structure comprises an intercept flag;
the control signal comprises a current state data structure;
the current state data structure comprises a fault indication associated with the virtual machine;
notifying the node service component when the action has been completed comprises sending an updated goal state data structure to the node service component; and
the updated goal state data structure does not comprise the intercept flag.

10. The system of claim 1, wherein:
the reboot event corresponds to a host machine; and
the action comprises at least one of:
updating an operating system on the host machine;
performing a firmware update on the host machine;
enabling or disabling basic input/output system (BIOS) features on the host machine;
updating a hosting environment corresponding to the host machine; or
moving a virtual machine to a different host machine.

11. The system of claim 1, wherein:
the reboot event corresponds to a virtual machine; and
the action comprises at least one of:
updating a guest operating system that is running on the virtual machine; or
moving the virtual machine to a different host machine.

12. The system of claim 1, further comprising a defragmentation component that is configured to perform at least one of:
setting an intercept flag for all virtual machines in the cloud computing system; or
identifying a subset of virtual machines that should be moved to a different host machine in order to create system capacity and setting the intercept flag for the subset of virtual machines.

13. The system of claim 1, wherein:
the computing entity is a virtual machine that is running on a host machine;
the action is related to the virtual machine; and
the operations further comprise performing an additional action that is related to the host machine in response to determining that no other virtual machines are running on the host machine.

14. A method for opportunistically performing an action in a cloud computing system, comprising:
detecting a reboot event corresponding to a computing entity in the cloud computing system;
causing the computing entity to be held in a stopped state;
performing the action while the computing entity is being held in the stopped state, thereby eliminating a need to perform the action at a future time subsequent to the reboot event, wherein the action would affect the computing entity if the action were performed subsequent to the reboot event; and
causing the computing entity to be started after the action has been performed.

15. The method of claim 14, wherein the computing entity comprises a host machine in the cloud computing system.

16. The method of claim 14, wherein the computing entity comprises a virtual machine in the cloud computing system.

17. The method of claim 14, wherein the action would cause the computing entity to be rebooted again if the action were performed subsequent to the reboot event.

18. A computer-readable medium having computer-executable instructions stored thereon that, when executed, cause one or more processors to perform operations comprising:
detecting a reboot event corresponding to a computing entity in a cloud computing system;
causing the computing entity to be held in a stopped state;
performing an action while the computing entity is being held in the stopped state, thereby eliminating a need to perform the action at a future time subsequent to the reboot event, wherein the action would affect the computing entity if the action were performed subsequent to the reboot event; and
causing the computing entity to be started after the action has been performed.

19. The computer-readable medium of claim 18, wherein the computing entity comprises a host machine in the cloud computing system.

20. The computer-readable medium of claim 18, wherein the computing entity comprises a virtual machine in the cloud computing system.
